(19) United States
(12) Patent Application Publication
(10) Pub. No.: US 2025/0388262 A1
(43) Pub. Date: Dec. 25, 2025

(54) ELECTRIC WHEELCHAIR, DRIVE SYSTEM FOR MOUNTING ON ELECTRIC WHEELCHAIR, METHOD FOR CONTROLLING ELECTRIC WHEELCHAIR, AND NON-TRANSITORY INFORMATION STORAGE MEDIUM STORING PROGRAM

(71) Applicant: Yamaha Hatsudoki Kabushiki Kaisha, Shizuoka (JP)

(72) Inventors: Toshiki SASAOKA, Shizuoka (JP); Masamitsu MIZUNO, Shizuoka (JP)

(21) Appl. No.: 19/246,656

(22) Filed: Jun. 23, 2025

(30) Foreign Application Priority Data
Jun. 25, 2024 (JP) 2024-102202

(51) Int. Cl. B62D 11/04; A61G 5/04

(52) U.S. Cl. CPC B62D 11/04; A61G 5/045; A61G 2203/30; A61G 2203/32

(57) ABSTRACT

When a force (torque) to turn a wheelchair 100 to a left direction is detected, a control device 20 increases a rotational speed of a right wheel motor 25R from a rotational speed corresponding to a common reference speed Vs and decreases a rotational speed of the left wheel motor 25Lfrom the rotational speed corresponding to the common reference speed Vs. Further, when the force to turn the wheelchair 100 to a right direction is detected, the control device 20 increases a rotational speed of the left wheel motor 25L from a rotational speed corresponding to the common reference speed and decreases a rotational speed of the right wheel motor 25R from the rotational speed corresponding to the common reference speed Vs.

### CROSS-REFERENCE TO RELATED APPLICATION

The present application claims priority from Japanese application No. 2024-102202 filed on Jun. 25, 2024, the content of which is hereby incorporated by reference into this application.

### BACKGROUND OF THE INVENTION

### 1. Field of the Invention

The present disclosure relates to an electric wheelchair, a drive system for mounting on the electric wheelchair, a method for controlling the electric wheelchair, and a non-transitory information storage medium storing a program.

### 2. Description of the Related Art

JPH09-130921A discloses the electric wheelchair having an electric motor on each of a right wheel and a left wheel for assisting the drive of the wheels. The electric wheelchair includes grips on the rear side to be held and pushed by a caregiver. In JPH09-130921A, when the caregiver operates a switch on the assisting operation unit, the left and right electric motors are driven so that the electric wheelchair travels at a constant speed.

The caregiver needs to push the left grip stronger than the right grip in order to turn the electric wheelchair in the right direction, and needs to push the right grip stronger than the left grip in order to turn the electric wheelchair in the left direction. Such a manner of turning may be a significant burden on the caregiver. For example, turning the wheelchair is particularly burdensome for the caregiver when the weight of the occupant of the electric wheelchair is heavy.

### SUMMARY OF THE INVENTION

(1) The present disclosure proposes a drive system for mounting on an electric wheelchair that has a right wheel and a left wheel. The drive system includes a right wheel motor that drives the right wheel, a left wheel motor that drives the left wheel, means for detecting an externally applied force (such as a force sensor) to turn the electric wheelchair, and a control device that controls the right wheel motor and the left wheel motor based on a common reference speed. When making a left turn in which the force to turn the electric wheelchair in a left direction is detected, the control device increases a rotational speed of the right wheel motor from a rotational speed corresponding to the common reference speed and decreases a rotational speed of the left wheel motor from the rotational speed corresponding to the common reference speed. When making a right turn in which the force to turn the electric wheelchair in a right direction is detected, the control device increases a rotational speed of the left wheel motor from a rotational speed corresponding to the common reference speed and decreases a rotational speed of the right wheel motor from the rotational speed corresponding to the common reference speed. This drive system can reduce the burden on the caregiver when turning the electric wheelchair, while reducing the changes in the speed of the electric wheelchair.
(2) In the drive system described in (1), when the force to turn the electric wheelchair is detected, the control device performs a first correction, which is either an addition of a correction value or a subtraction of a correction value. The control device controls one of the right wheel motors and one of the left wheel motors based on a result of the first correction, and then performs a second correction. The second correction is the other one of the addition of the correction value and the subtraction of the correction value, and the control device controls the other one of the right wheel motor and the left wheel motor based on a result of the second correction.
(3) In the drive system described in (1), at the time of the left turn, the control device controls the right wheel motor based on an addition result and controls the left wheel motor based on a subtraction result, where the addition result is a result of adding a correction value to the common reference speed, and the subtraction result is a result of subtracting the correction value from the common reference speed. At the time of the right turn, the control device controls the left wheel motor based on the addition result and controls the right wheel motor based on the subtraction result, where the addition result is a result of adding a correction value to a common reference speed, and the subtraction result is a result of subtracting the correction value from the common reference speed.
(4) The drive system described in (2) further includes a right speed sensor that outputs a signal corresponding to the speed of the right wheel; and a left speed sensor that outputs a signal corresponding to the speed of the left wheel. When a difference between the speed obtained by the right speed sensor and the speed obtained by the left speed sensor satisfies a predetermined condition, the control device relaxes at either the first correction or the second correction so that a difference between a rotational speed of the left wheel motor and a rotational speed of the right wheel motor is reduced. This serves to prevent an excessively high turning speed.
(5) In the drive system described in any one of (1) to (4), the control device calculates the correction value based on at least one of the forces to turn the electric wheelchair or the speed of the electric wheelchair and an upper limit value that is set for the correction value in advance. This serves to keep the correction value smaller than the upper limit value, for example, and increase the correction value in accordance with the force to turn the electric wheelchair. Alternatively, the correction value can be kept smaller than the upper limit value and set to a value corresponding to the speed of the electric wheelchair.
(6) In the drive system described in any one of (1) to (5), the control device calculates the common reference speed according to an operation amount acting on an operation member included in the electric wheelchair. In this manner, the electric wheelchair can be controlled to travel at a speed corresponding to the operation amount.
(7) In the drive system described in any one of (1) to (6), the control device calculates the correction value based on an externally applied force (such as a force sensor) acting on the electric wheelchair. In this manner, it is possible to obtain assistance corresponding to the force acting on the electric wheelchair, that is, the force applied to the electric wheelchair by the caregiver.
(8) In the drive system described in any one of (1) to (7), the control device calculates the force to turn the electric wheelchair based on an angular speed around a vertical axis line of the electric wheelchair.
(9) The drive system described in any one of (1) to (8) includes a right speed sensor that outputs a signal corresponding to a speed of the right wheel and a left speed sensor that outputs a signal corresponding to a speed of the left wheel. The control device controls the right wheel motor and the left wheel motor based on a difference between an average of the right wheel speed and the left wheel speed and the common reference speed. Upon detecting the force to turn the electric wheelchair, the control device adds a correction value to either the average speed or the common reference speed to control one of the right wheel motors and the left wheel motors. The control device then subtracts the correction value from the average speed and the common reference speed to control the other one of the right wheel motor and the left wheel motor.
(10) In the drive system described in any one of (2) to (9), the control device calculates the correction value based on the speed of the electric wheelchair. This can prevent turning at high speed.
(11) In the drive system described in (10), a first correction value is calculated when the speed of the electric wheelchair is a first speed that is smaller than a threshold value. A second correction value is calculated when the speed of the electric wheelchair is a second speed that is greater than the threshold value, and the first correction value is greater than the second correction value. This can prevent sudden turning at high speed.
(12) In the drive system described in any one of (1) to (11), the control device detects an operation applied by a caregiver to an operation member provided on the electric wheelchair, and limits the common reference speed to a predetermined value or less in response to the operation. This serves to keep the speed of the electric wheelchair low, and the turning can be assisted by the wheel motors. In this manner, turning in a narrow space can be easily performed.
(13) In the drive system described in any one of (2) to (13), the control device receives a command from a user for changing an upper limit value of the correction value. This prevents excessive turning assistance that is not intended by the user.
(14) In the drive system described in (2), when the common reference speed is lower than the correction value, the control device sets the rotation speed of one of the right wheel motors and the left wheel motors as a positive value by the first correction, and sets the rotation speed of the other right wheel motor and left wheel motor as a negative value by the second correction. According to this configuration, the space required for turning can be reduced, and the burden required for turning can be reduced.
(15) The electric wheelchair proposed in the present disclosure includes the drive system described in any one of (1) to (14), and the right wheel and the left wheel.
(16) The present disclosure proposes a method for controlling an electric wheelchair including a right wheel, a left wheel, a right wheel motor that drives the right wheel, and a left wheel motor that drives the left wheel. The controlling method includes the steps of detecting an externally applied force (such as a force sensor) to turn the electric wheelchair and controlling the right wheel motor and the left wheel motor based on a common reference speed. The controlling step includes, at a time of left turn in which the force to turn the electric wheelchair to a left direction is detected, increasing a rotational speed of the right wheel motor from a rotational speed corresponding to the common reference speed and decreasing a rotational speed of the left wheel motor from the rotational speed corresponding to the common reference speed. Further, the controlling step includes, at a time of right turn in which the force to turn the electric wheelchair to a right direction is detected, increasing a rotational speed of the left wheel motor from a rotational speed corresponding to the common reference speed and decreasing a rotational speed of the right wheel motor from the rotational speed corresponding to the common reference speed. This controlling method restricts the changes in the speed of the electric wheelchair and thereby reduces the burden on the caregiver when turning the electric wheelchair.
(17) The present disclosure proposes a program for causing a computer to function as a control device of an electric wheelchair including a right wheel, a left wheel, a right wheel motor that drives the right wheel, and a left wheel motor that drives the left wheel. The program causes the computer to function as a means for detecting an externally applied force (such as a force sensor) to turn the electric wheelchair and means for controlling the right wheel motor and the left wheel motor based on a common reference speed. The controlling means includes means for, at a time of left turn in which the force to turn the electric wheelchair to a left direction is detected, increasing a rotational speed of the right wheel motor from a rotational speed corresponding to the common reference speed and decreasing a rotational speed of the left wheel motor from the rotational speed corresponding to the common reference speed. Further, the controlling means includes means for, at a time of right turn in which the force to turn the electric wheelchair to a right direction is detected, increasing a rotational speed of the left wheel motor from a rotational speed corresponding to the common reference speed and decreasing a rotational speed of the right wheel motor from the rotational speed corresponding to the common reference speed. This program restricts the changes in the speed of the electric wheelchair and thereby reduces the burden on the caregiver when turning the electric wheelchair.

### BRIEF DESCRIPTION OF THE DRAWINGS

FIG. 1 is a perspective view of an electric wheelchair;

FIG. 2 is a block diagram of the drive system of the electric wheelchair;

FIG. 3 is a block diagram showing functions of the control device shown in FIG. 2;

FIG. 4A is a schematic diagram to explain controlling executed by the control device;

FIG. 4B is a diagram illustrating turning in reverse mode;

FIG. 5A is a diagram showing an example of relationship between a wheelchair speed and a speed influence rate used for calculating a correction speed;

FIG. 5B is a diagram illustrating an example of the relationship between the torque influence rate to be used for calculating the correction speed and the ratio of the detected input turning torque to the maximum value of the turning torque;

FIG. 6A is a flow chart indicating the processing executed by the control device;

FIG. 6B is a flow chart indicating the processing executed by the control device;

FIG. 7 is a time chart showing (a) input turning torque, (b) reference speed, and (c) output torque of wheel motors, and

FIG. 8 is a time chart showing another example of changes in (a) input turning torque, (b) reference speed, and (c) output torque of wheel motors.

### DETAILED DESCRIPTION OF THE INVENTION

The present disclosure is to be considered as an exemplification of the invention, and is not intended to limit the invention to the specific embodiments illustrated by the figures or description below. The present invention will now be described by referencing the appended figures representing embodiments.

The terminology used herein is for the purpose of describing particular embodiments only and is not intended to be limiting of the invention. As used herein, the term “and/or” includes any and all combinations of one or more of the associated listed items. As used herein, the singular forms “a”, “an”, and “the” are intended to include the plural forms as well as the singular forms, unless the context clearly indicates otherwise. It will be further understood that the terms “comprises”, “comprising”, “includes”, and/or “including”, when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of technologies are disclosed. Each of these has individual benefit and each can also be used in conjunction with one or more, or in some cases all, of the other disclosed technologies. Accordingly, for the sake of clarity, this description will refrain from repeating every possible combination of the individual technologies in an unnecessary fashion. Nevertheless, the specification and claims should be read with the understanding that such combinations are entirely within the scope of the invention and the claims.

In the following, an electric wheelchair, a drive system, a method of controlling the electric wheelchair, and a program proposed in the present disclosure will be described.

In the following description, for purposes of explanation, numerous specific details are set forth in order to provide a thorough understanding of the present invention. It will be evident, however, to one skilled in the art that the present invention may be practiced without these specific details.

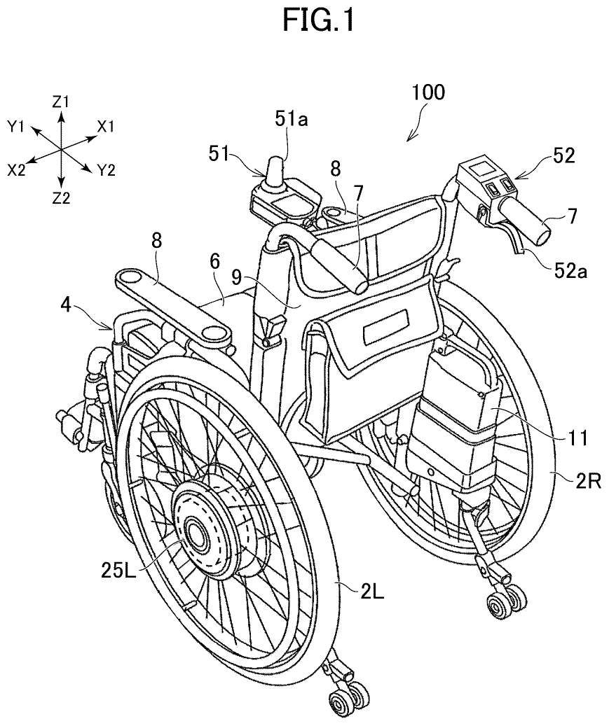

In the description below, Y1 and Y2 directions shown in FIG. 1 are referred to as a forward direction and a backward direction, respectively. Further, Z1 and Z2 directions shown in FIG. 1 are referred to as an upward direction and a downward direction, respectively, and X1 and X2 directions shown in FIG. 1 are referred to as a right direction and a left direction, respectively.

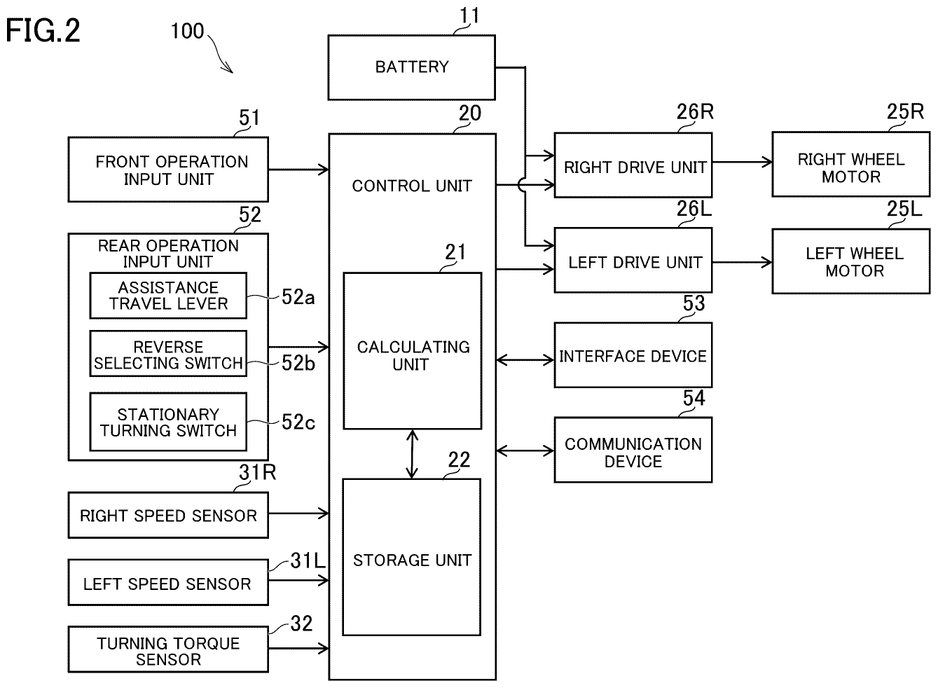

As shown in FIG. 1, an electric wheelchair 100 has a right wheel 2R and a left wheel 2L. The wheelchair 100 includes a right wheel motor 25R (see FIG. 2) for driving the right wheel 2R and a left wheel motor 25L (see FIGS. 1 and 2) for driving the left wheel 2L. The rotation of the wheel motors 25R and 25L may be transmitted to the wheels 2R and 2L via a speed reduction mechanism, or may be directly transmitted to the wheels 2R and 2L without the speed reduction mechanism.

The right wheel motor 25R may be provided in a hub of the right wheel 2R, and the left wheel motor 25L may be provided in a hub of the left wheel 2L. In other words, the wheel motors 25R and 25L may be so-called in-wheel motors. The positions at which the wheel motors 25R and 25L are disposed are not limited to the example shown in FIG. 1. The wheel motors 25R and 25L may be placed in positions other than the hubs of the wheels 2R and 2L, and the torque thereof may be transmitted via a transmission mechanism, such as a chain.

As shown in FIG. 1, the wheelchair 100 includes a seat 6 disposed between the right wheel 2R and the left wheel 2L, and a backrest 9 disposed on the rear side of the seat 6 to support the occupants back on the seat 6. The wheelchair 100 also includes armrests 8 on the right and left sides of the seat 6 for the occupant to place their arms. The wheels 2R and 2L, the seat 6, the backrest 9, and the armrests 8 are supported by a body frame 4.

As shown in FIG. 1, the wheelchair 100 includes left and right handle grips 7 extending rearward from the backrest 9 to be gripped by hands of a caregiver. The caregiver holds the left and right handle grips 7 and pushes the wheelchair 100 forward and backward, thereby moving the wheelchair 100.

As shown in FIG. 1, the wheelchair 100 includes a front operation input unit 51. The front operation input unit 51 is provided in front of the right armrest 8, for example, and operated by an occupant sitting on the seat 6. The front operation input unit 51 may include a travel operation stick 51a. The travel operation stick 51a can be tilted forward, rightward, leftward, and obliquely relative thereto from its neutral position. The front operation input unit 51 includes a sensor (not shown) for detecting a tilt angle and a tilt direction of the travel operation stick 51a, and inputs a signal corresponding to the tilt angle and the tilt direction to a control device 20 (see FIG. 2).

When the travel operation stick 51a is tilted, the control device 20 drives the wheel motors 25R and 25L at a speed corresponding to the tilt direction and the tilt angle. This allows the occupant to move the wheelchair 100 in a desired direction at a desired speed. The control device 20 stops the driving of the wheel motors 25L and 25R when the travel operation stick 51a is returned to the neutral position.

As shown in FIG. 1, the wheelchair 100 includes a rear operation input unit 52. The rear operation input unit 52 is provided on the right handle grip 7, for example, and operated by the caregiver. As shown in FIG. 2, the rear operation input unit 52 includes an assistance travel lever (operation member) 52a and a reverse selecting switch (reverse selection input unit) 52b, for example. The rear operation input unit 52 inputs, to the control device 20, a signal corresponding to an operation amount of the assistance travel lever 52a by the caregiver.

The rear operation input unit 52 inputs a signal corresponding to an operation (on/off operation) of the reverse selecting switch 52b to the control device 20. When the reverse selecting switch 52b is in the on-state, the reverse mode is selected, and the control device 20 drives the wheel motors 25R and 25L so that the wheelchair 100 moves backward at a speed corresponding to the operation of the assistance travel lever 52a. On the other hand, when the reverse selecting switch 52b is in the off-state, the forward mode is selected, and the control device 20 drives the wheel motor 25R and 25L so that the wheelchair 100 moves forward at a speed corresponding to the operation of the assistance travel lever 52a. Unlike the example shown in FIG. 2, the wheelchair 100 may include a forward selecting switch for selecting the forward mode.

The rear operation input unit 52 may have an operation member that is different from the assistance travel lever 52a. The control device 20 may drive the wheel motors 25R and 25L such that the wheelchair 100 moves forward or backward at a speed corresponding to an operation performed on such an operation member. For example, the rear operation input unit 52 may include a dial for setting a speed, a forward selecting switch, and a reverse selecting switch. When the forward selecting switch is turned on, the control device 20 may drive the wheel motors 25R and 25L at a speed corresponding to the operation amount of the dial so as to move the wheelchair 100 forward. When the reverse selecting switch is turned on, the control device 20 may drive the wheel motors 25R and 25L at a speed corresponding to the operation amount of the dial so as to move the wheelchair 100 backward.

As shown in FIG. 2, the rear operation input unit 52 may include a stationary turning switch 52c. When the stationary turning switch 52c is operated, the wheelchair 100 drives the wheel motors 25R and 25L so as to assist the turning operation by the caregiver while the wheelchair is stationary (while the center position of the wheelchair 100 is not changed). The control when the stationary turning switch 52c is operated will be described later. As shown in FIG. 2, the wheelchair 100 includes a right speed sensor 31R that inputs a signal corresponding to the speed of the right wheel 2R to the control device 20, and a left speed sensor 31L that inputs a signal corresponding to the speed of the left wheel 2L to the control device 20. The speed sensors 31R and 31L output a signal corresponding to the rotational speed, and may include an encoder, for example.

The speed sensors 31R and 31L may be installed at any positions if a signal corresponding to the speed of the wheels 2R and 2L can be output. For example, the speed sensors 31R and 31L may be attached to the wheels 2R and 2L or to the wheel motors 25R and 25L.

The control device 20 calculates the speed of the wheels 2R and 2L (speed in the front-rear direction) and the speed of the wheelchair 100 based on the output (rotational speed) of the speed sensors 31R and 31L and the radials of the wheels 2R and 2L. The speed of the wheelchair 100 may be the average of the speeds of the left and right wheels 2R and 2L, for example. In the following, the speed of the wheelchair 100 is referred to as “wheelchair speed.” Further, the speed obtained by multiplying the rotational speed of the right wheel 2R by the radius of the right wheel 2R is referred to as “right wheel speed”, and the speed obtained by multiplying the rotational speed of the left wheel 2L by the radius of the left wheel 2L is referred to as “left wheel speed.”

As shown in FIG. 2, the wheelchair 100 may include a turning torque sensor 32. The turning torque sensor 32 outputs a signal corresponding to torque (turning torque) of the wheelchair 100 around the axis line along the vertical direction (Z1-Z2 direction) of the wheelchair 100. The turning torque sensor 32 may be an angular speed sensor. The control device 20 may calculate the turning torque based on the output of the angular speed sensor.

The wheelchair 100 may not necessarily have to include the turning torque sensor 32. In this case, the control device 20 may calculate the turning torque based on the output of the speed sensors 31R and 31L. This calculation of the control device 20 will be described later.

As shown in FIG. 2, the control device 20 includes a calculating unit 21 and a storage unit 22. The calculating unit 21 may include a CPU (central processing unit), a microprocessor, an FPGA (field programmable gate array), for example. The storage unit 22 includes a ROM (read only memory), a RAM (random access memory), for example, and stores a program to be executed by the calculating unit 21 and a table to be used in executing the program.

The control device 20 executes, in the calculating unit 21, the program stored in the storage unit 22 so as to control the wheel motors 25R and 25L in accordance with the operation of the operation input units 51 and 52. In the example disclosed herein, when the caregiver turns the wheelchair 100, the control device 20 drives the wheel motors 25R and 25L to assist the operation of the caregiver. The control performed by the control device 20 will be described in detail later.

As shown in FIG. 2, the wheelchair 100 includes a right drive unit 26R and a left drive unit 26L. The current from the battery 11 is supplied to the drive units 26R and 26L. The control device 20 calculates a command value based on a signal input from the operation input units 51 and 52. The right drive unit 26R uses a current from the battery 11 and supplies the current corresponding to the command to the right wheel motor 25R. The left drive unit 26L uses a current from the battery 11 and supplies the current corresponding to the command to the left wheel motor 25L.

The wheel motors 25R and 25L may be a DC motor, for example. The drive units 26R and 26L include a DC/DC converter and supply a current corresponding to the command to the wheel motors 25R and 25L. The wheel motors 25R and 25L may be an AC motor. In this case, the drive units 26R and 26L may include an inverter and use a current from the battery 11 to supply the current of a frequency corresponding to the command value to the wheel motors 25R and 25L.

The drive system of the electric wheelchair 100 may include the control device 20 shown in FIG. 2, the wheel motors 25R and 25L, the drive units 26R and 26L, the rear operation input unit 52, and the speed sensors 31R and 31L, for example. The drive system may not include the wheels 2R and 2L shown in FIG. 1 and the seat 6 as the elements.

### Control Device

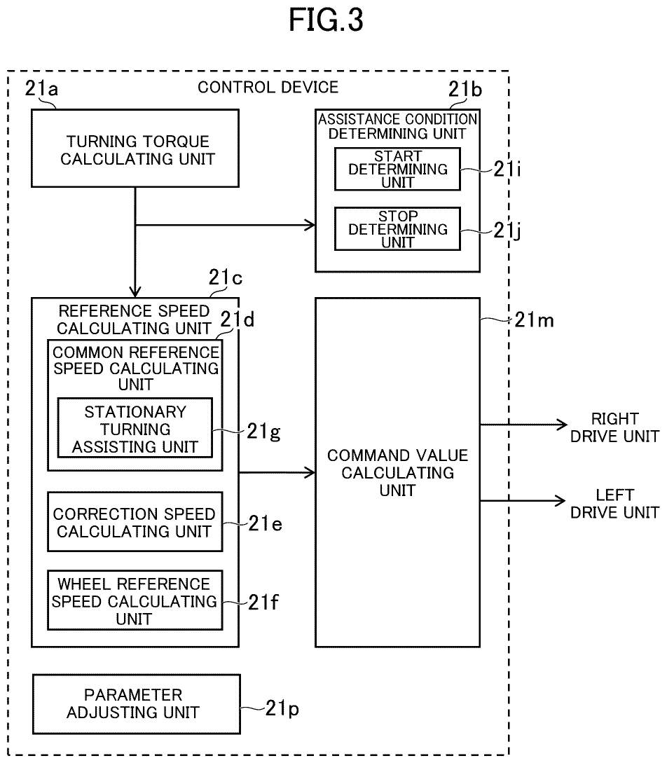

FIG. 3 is a block diagram showing functions of the control device 20. The control device 20 functionally includes a turning torque calculating unit 21a, an assistance condition determining unit 21b, a reference speed calculating unit 21c, a command value calculating unit 21m, and a parameter adjusting unit 21p. These functions are implemented when the calculating unit 21 executes the program stored in the storage unit 22.

### Turning Torque Calculating Unit

When the caregiver turns the wheelchair 100 in the left direction (X2 direction, see FIG. 1) while moving the wheelchair forward, the caregiver pushes the right handle grip 7 forward stronger than the left handle grip 7. This generates turning torque in the left direction in the wheelchair 100. In contrast, when the caregiver turns the wheelchair 100 in the right direction (X1 direction, see FIG. 1) while moving the wheelchair forward, the caregiver pushes the left handle grip 7 forward stronger than the right handle grip 7. This generates turning torque in the right direction in the wheelchair 100. The turning torque calculating unit 21a detects a force (torque) acting from the outside (specifically, the caregiver) for turning the wheelchair 100. In the following, such torque is referred to as “input turning torque.”

An example of the wheelchair 100 may include the turning torque sensor 32 as described above. The turning torque sensor 32 is an angular speed sensor, for example. The turning torque calculating unit 21a may calculate the torque applied to the wheelchair 100 by the caregiver based on the angular speed. The turning torque calculating unit 21a may calculate the input turning torque based on the time derivative of the angular speed detected by the angular speed sensor 32.

The sensor used to calculate the input turning torque is not limited to the turning torque sensor 32 (angular speed sensor). For example, sensors (magneto-strictive sensors) that output a signal corresponding to the twisting (distortion) of the handle grip 7 may be attached to the left and right handle grips 7. The control device 20 may calculate the turning torque applied to the wheelchair 100 by the caregiver based on the output of the sensor (force applied in the right direction or the left direction).

As yet another example, acceleration sensors may be attached to the right portion and the left portion of the wheelchair 100. The control device 20 may calculate the turning torque applied to the wheelchair 100 by the caregiver based on the difference between the acceleration of the right portion and the acceleration of the left portion obtained from the two acceleration sensors (i.e., the difference between the force acting on the right portion and the force acting on the left portion). The output of the acceleration sensor may be affected by the inclination of the place where the wheelchair 100 is traveling. As such, the turning torque may be calculated using the acceleration sensor only in a flat place.

In yet another example, the turning torque calculating unit 21a may calculate the input turning torque based on a right wheel speed obtained from the output of the right speed sensor 31R and a left wheel speed obtained from the output of the left speed sensor 31L. For example, the turning torque calculating unit 21a may calculate the input turning torque by the following Equation (1):

$$Th = \frac{d}{dt} ( I \frac{VR - VL}{Wh} ) \qquad Equation ( 1 )$$

In the above equation (1), the characters represent values of the followings:
Th: Input turning torque
I: Moment of inertia of wheelchair
VR: Right wheel speed
VL: Left wheel speed
Wh: Distance between right and left wheels in left-right direction

As will be described later, when the input turning torque described above is applied to the wheelchair 100 by the caregiver, the control device 20 controls the wheel motors 25R and 25L to assist such turning operation. As such, after the assistance operation for turning is started, the torque caused by the driving of the wheel motors 25R and 25L also acts on the wheelchair 100. The turning torque calculating unit 21a may subtract the torque caused by the driving of the wheel motors 25R and 25L from the turning torque calculated by the processing described above. The turning torque calculating unit 21a may use a result of the subtraction as the input turning torque applied by the caregiver.

For example, the turning torque calculating unit 21a may calculate the input turning torque by the following Equation (2). In the Equation (2), the second term on the right side is the torque generated in the wheelchair 100 by driving the wheel motors 25R and 25L.

$$Th = \frac{d}{dt} ( I \frac{VR - VL}{Wh} ) - \frac{d}{dt} ( I \frac{2 \times Vc}{Wh} ) \qquad Equation ( 2 )$$

Th: Input turning torque applied by caregiver to wheelchair
I: Moment of inertia of wheelchair
VR: Right wheel speed
VL: Left wheel speed
Wh: Distance between right and left wheels in left-right direction
Vc: Difference between right wheel reference speed used for controlling right wheel motor and left wheel reference speed used for controlling left wheel motor (“reference speed” will be described in detail later).

### Assistance Condition Determining Unit

As shown in FIG. 3, the assistance condition determining unit 21b includes a start determining unit 21i. The start determining unit 21i determines whether a condition for starting the assistance of the wheel motors 25R and 25L for turning (assistance start condition) is satisfied. The assistance start condition includes a condition regarding the input turning torque described above. For example, when the input turning torque is equal to or greater than a predetermined threshold value, it is determined that the assistance start condition is satisfied, and the wheel motors 25R and 25L start assisting the turning. This can avoid erroneously detecting that the caregiver intends to turn the wheelchair and starting the assistance of the wheel motors 25R and 25L in an operation without the intention of turning. The wheel motors 25R and 25L may support the turning of the wheelchair when the input turning torque is more than a predetermined threshold value and continues for a predetermined period of time.

The assistance start condition may include a condition about the speed of the wheelchair 100. For example, when the input turning torque is equal to or greater than a predetermined threshold value and the wheelchair speed is lower than the threshold value, it may be determined that the assistance start condition is satisfied. This enables to prevent the assistance for turning when the speed of the wheelchair 100 is high.

When the difference between the right wheel speed VR and the left wheel speed VL satisfies the predetermined condition during the turning, the assistance condition determining unit 21b relaxes at least one of an addition correction and a subtraction correction so that the difference between the rotational speed of the left wheel motor 25L and the rotational speed of the right wheel motor 25R is reduced. In this regard, relaxing the correction includes stopping the correction and reducing the correction speed Vc, for example.

The assistance condition determining unit 21b may include a stop determining unit 21j. The stop determining unit 21j determines whether the condition (assistance stop condition) for stopping the assistance of the wheel motors 25R and 25L for turning is satisfied. For example, when the difference between the right wheel speed VR and the left wheel speed VL is larger than the threshold value, it is determined that the assistance stop condition is satisfied, and the assistance of the wheel motors 25R and 25L for turning may be stopped. This can prevent the wheelchair 100 from turning at excessively high speed. When the difference between the right wheel speed VR and the left wheel speed VL is larger than the threshold value during the turning, the assistance condition determining unit 21b may stop only the addition correction.

### Outline of Correction

The control device 20 controls the right wheel motor 25R and the left wheel motor 25L based on a common reference speed Vs. The common reference speed Vs serves as a target value set for the wheelchair speed. The common reference speed Vs is determined based on the operation amount of the assistance travel lever 52a, for example. In this manner, the wheelchair 100 can be controlled to travel at a speed corresponding to the operation amount. The common reference speed Vs may be a predetermined fix value that does not depend on the operation amount of the assistance travel lever 52a.

In the following, the travel in which the assistance of the wheel motors 25R and 25L for turning is provided is referred to as “turning assisted travel”, and the travel in which the assistance of the wheel motors 25R and 25L for turning is not provided is referred to as “normal travel.”

### Normal Travel

In the normal travel, the control device 20 outputs a command value to the drive units 26R and 26L. The command value corresponds to a difference between the average (VR+VL)/2) of the right wheel speed VR and the left wheel speed VL and the common reference speed Vs. In this manner, the wheel motors 25R and 25L are driven such that the wheelchair speed (average of wheel speeds VR and VL) follows the common reference speed Vs.

As described above, the right wheel speed VR can be calculated based on the output (rotational speed) of the right speed sensor 31R and the radius of the right wheel 2R, for example. The left wheel speed VL can be calculated based on the output (rotational speed) of the left speed sensor 31L and the radius of the left wheel 2L, for example. In the following, the average of the right wheel speed VR and the left wheel speed VL is referred to as “left and right wheel average speed V_ave.”

### Turning Assisted Travel

When a force to turn the wheelchair 100 is detected by the turning torque calculating unit 21a, more specifically, when the assistance start condition described above is satisfied, the turning assisted travel is executed. At the time of the left turn in which the force for turning in the left direction is detected, the control device 20 increases the rotational speed of the right wheel motor 25R from the rotational speed corresponding to the common reference speed Vs, and decreases the rotational speed of the left wheel motor 25L from the rotational speed corresponding to the common reference speed Vs. In this manner, while reducing the change in the speed of the wheelchair 100, the wheel motors 25R and 25L can assist for turning in the left direction.

At the time of the right turn in which the force for turning in the right direction is detected, the control device 20 increases the rotational speed of the left wheel motor 25L from the rotational speed corresponding to the common reference speed Vs, and decreases the rotational speed of the right wheel motor 25R from the rotational speed corresponding to the common reference speed Vs. In this manner, the change in the speed of the wheelchair 100 can be reduced and the wheel motors 25R and 25L can assist for turning in the right direction.

### Correction of Reference Speed

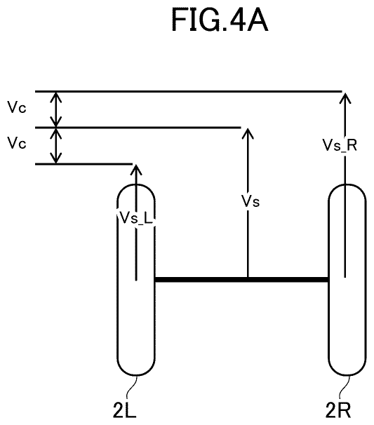

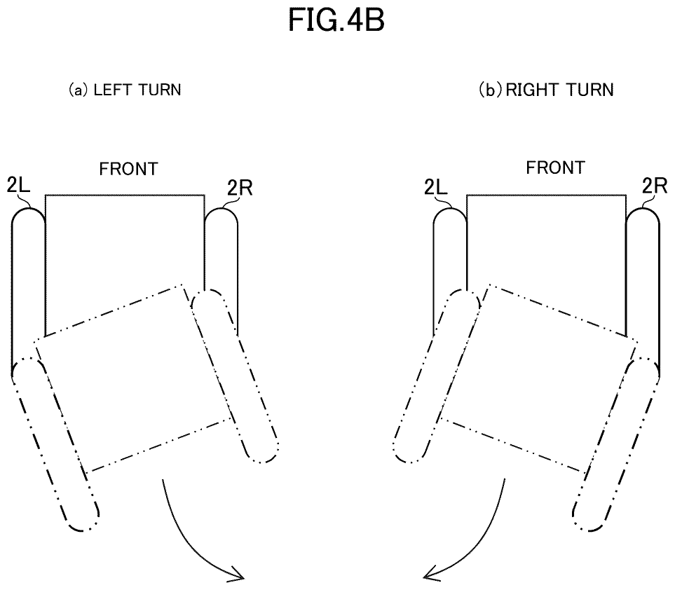

The control device 20 calculates a reference speed for the right wheel 2R (right wheel reference speed Vs_R) and a reference speed for the left wheel 2L (left wheel reference speed Vs_L). FIG. 4A is a diagram to explain the processing executed in a turning assisted travel in the left direction. As shown in FIG. 4A, in the turning assisted travel in the left direction, the control device 20 adds a correction value (correction speed Vc) to the common reference speed Vs, for example, and sets the result of the addition correction as the right wheel reference speed Vs_R. Further, the control device 20 subtracts the same correction value (correction speed Vc) from the common reference speed Vs, and sets the result of the subtraction correction as the left wheel reference speed Vs_L.

The control device 20 outputs a command value to the right drive unit 26R. The command value corresponds to the difference (Vs_R−V_ave) between the right wheel reference speed Vs_R and the left and right wheel average speed V_ave. This increases the rotational speed of the right wheel motor 25R from the rotational speed corresponding to the common reference speed Vs.

The control device 20 outputs a command value to the left drive unit 26L. The command value corresponds to the difference (Vs_L−V_ave) between the left wheel reference speed Vs_L and the left and right wheel average speed V_ave. This reduces the rotational speed of the left wheel motor 25L from the rotational speed corresponding to the common reference speed Vs. In this manner, while reducing the change in the speed of the wheelchair, the wheel motors 25R and 25L can assist for turning in the left direction.

Similar processing is also executed in the turning assisted travel in the right direction. Specifically, in the turning assisted travel in the right direction, the control device 20 adds the correction value (correction speed Vc) to the common reference speed Vs, and sets the result of the addition correction as the left wheel reference speed Vs_L. Further, the control device 20 subtracts the same correction value (correction speed Vc) from the common reference speed Vs, and sets the result of the subtraction correction as the right wheel reference speed Vs_R.

After that, the control device 20 outputs, to the right drive unit 26R, a command value corresponding to the difference between the left wheel reference speed Vs_L and the left and right wheel average speed V_ave. This increases the rotational speed of the left wheel motor 25L from the rotational speed corresponding to the common reference speed Vs. The control device 20 outputs, to the right drive unit 26R, a command value corresponding to the difference between the right wheel reference speed Vs_R and the left and right wheel average speed V_ave. This reduces the rotational speed of the right wheel motor 25R from the rotational speed corresponding to the common reference speed Vs. In this manner, while reducing the change in the speed of the wheelchair, the wheel motors 25R and 25L can assist for turning in the right direction.

### Reference Speed Calculating Unit

In the following, the controlling of the control device 20 will be described in detail. As shown in FIG. 3, the reference speed calculating unit 21c includes a common reference speed calculating unit 21d, a correction speed calculating unit 21e, and a wheel reference speed calculating unit 21f.

The common reference speed calculating unit 21d calculates a common reference speed Vs. The common reference speed calculating unit 21d detects an operation amount (lever operation amount) of the assistance travel lever 52a, for example, and calculates a common reference speed Vs corresponding to the lever operation amount. The storage unit 22 may store in advance a map or a relational expression that relates the lever operation amount to the common reference speed.

When the reverse selecting switch 52b is in the “on” state, that is, when the reverse mode is selected, the common reference speed calculating unit 21d may calculate a negative common reference speed Vs corresponding to the lever operation amount. On the other hand, when the reverse selecting switch 52b is in the “off” state, that is, when the forward mode is selected, the common reference speed calculating unit 21d may calculate a positive common reference speed Vs corresponding to the lever operation amount.

### Correction Speed Calculating Unit

The correction speed calculating unit 21e calculates a correction speed Vc to be added to or subtracted from the common reference speed Vs. The correction speed Vc may be set based on the input turning torque Th calculated by the turning torque calculating unit 21a. The correction speed Vc may have the upper limit Vc_max in advance (In the following, such an upper limit Vc_max is referred to as “upper limit correction speed”). The correction speed Vc may be calculated based on the turning torque Th and the upper limit correction speed Vc_max. The correction speed Vc may be calculated, for example, using Equation (3) below:

$$Vc = Vc\_max \times \frac{Th}{Th\_max} \qquad Equation ( 3 )$$

Vc_max: Upper limit correction speed
Th: Input turning torque
Th_max: Expected maximum input turning torque
With such a calculation, the correction speed Vc can be kept lower than the upper limit correction speed Vc_max and can be increased in accordance with an increase in the input turning torque. The storage unit 22 may previously store the upper limit correction speed Vc_max set in advance for the correction speed Vc and the maximum value Th_max of the input turning torque.

The processing of calculating the correction speed Vc is not limited to the above-described embodiment. The correction speed calculating unit 21e may calculate the correction speed Vc based on the turning torque Th detected by the turning torque calculating unit 21a and the speed of the wheelchair 100 (wheelchair speed Vwh), for example. For example, the correction speed Vc may be calculated based on the upper limit correction speed Vc_max, the turning torque Th, and the wheelchair speed Vwh. For example, the correction speed Vc may be calculated using Equation (4) below:

$$Vc = Vc\_max \times Rv \times Rt \qquad Equation ( 4 )$$

Vc_max: Upper limit correction speed
Rv: Percentage calculated according to wheelchair speed Vwh (speed influence rate)
Rt: Percentage calculated according to input turning torque Th (torque influence rate)

The speed influence rate Rv may be a relatively high value when the wheelchair speed Vwh is in the low speed range, for example. Further, the speed influence rate Rv may be a relatively low value when the wheelchair speed Vwh is in the high speed range, for example. The speed influence rate Rv may gradually decrease as the wheelchair speed Vwh increases in some or all speed ranges.

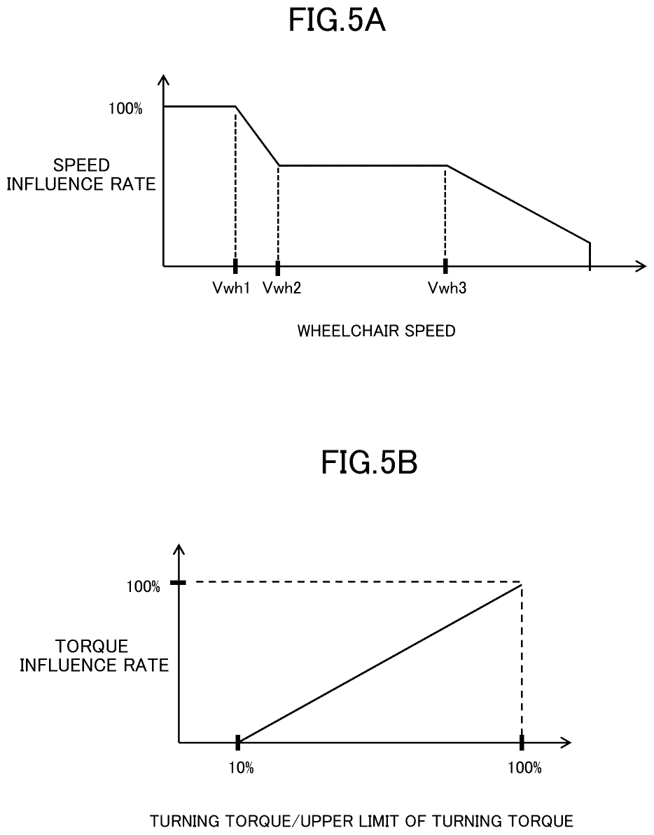

FIG. 5A is a diagram illustrating a relationship between the wheelchair speed Vwh and the speed influence rate Rv. The storage unit 22 may store a map representing such a relationship. The correction speed calculating unit 21e may refer to the map and calculate the speed influence rate Rv corresponding to the wheelchair speed Vwh.

In the example shown in FIG. 5A, the speed influence rate Rv is 100% in the low speed range (0<Vwh≤Vwh1), and 50% in the medium speed range (Vwh2<Vwh≤Vwh3). Further, the speed influence rate Rv gradually decreases with the speed in the high speed range (Vwh3<Vwh). The relationship between the wheelchair speed Vwh and the speed influence rate Rv is not limited to the example shown in FIG. 5A, and may be changed as appropriate.

Here, a first correction speed is defined as the correction speed Vc calculated when the wheelchair speed Vwh is in a low speed range smaller than the speed Vwh1. Further, a second correction speed is defined as the correction speed Vc calculated when the wheelchair speed Vwh is in a speed range (medium speed range or high speed range) higher than the speed Vwh1. When using a speed influence rate Rv described above, the first correction speed Vc is larger than the second correction speed Vc. This increases the assistance of the wheel motors 25R and 25L for turning when the wheelchair speed Vwh is in a low speed range smaller than the speed Vwh1.

The torque influence rate Rt may be increased gradually as the input turning torque Th increases, for example. FIG. 5B is a diagram illustrating an example of the relationship between the torque influence rate Rt and the ratio (turning torque ratio) of the input turning torque Th to the maximum value Th_max of the turning torque. The storage unit 22 may store a map representing such a relationship. The correction speed calculating unit 21e may refer to the map and calculate the torque influence rate Rt corresponding to the turning torque Th.

In the example shown in FIG. 5B, when the turning torque ratio is 10% or less, the torque influence rate Rt is 0. When the turning torque ratio is higher than 10%, the torque influence rate Rt gradually increases with an increase in the turning torque ratio.

The wheelchair speed Vwh is used to calculate the correction speed Vc, but the turning torque Th may not be used. For example, the correction speed calculating unit 21e may calculate the correction speed Vc based on the upper limit correction speed Vc_max and the wheelchair speed Vwh. In this case, the turning torque Th may not be used. For example, the correction speed calculating unit 21e may calculate the correction speed Vc by using Equation (5) below:

$$Vc = Vc\_max \times Rv \qquad Equation ( 5 )$$

Vc_max: Upper limit correction speed
Rv: Percentage calculated according to wheelchair speed Vwh (speed influence rate)
The speed influence rate Rv may be calculated using the map representing the relationship shown in FIG. 5A, for example.

### Wheel Reference Speed Calculating Unit (Forward Mode)

The wheel reference speed calculating unit 21f calculates a reference speed for the right wheel 2R (right wheel reference speed Vs_R) and a reference speed for the left wheel 2L (left wheel reference speed Vs_L).

When the wheelchair 100 moves forward and turns to the left, the wheel reference speed calculating unit 21f adds the correction speed Vc to the common reference speed Vs (addition correction), and sets the result of the addition correction as the right wheel reference speed Vs_R. Further, the wheel reference speed calculating unit 21f subtracts the correction speed Vc from the common reference speed Vs (subtraction correction), and sets the result of the subtraction correction as the left wheel reference speed Vs_L. That is, the reference speeds Vs_R and Vs_L are calculated as follows:

$$Vs\_R = Vs + Vc ( addition correction ) \\ Vs\_L = Vs - Vc ( subtraction correction )$$

(In the equations above, Vs≥0, Vc>0)

With such processing, the wheel motors 25R and 25L assist for the left turn. When the common reference speed Vs is low, the right wheel reference speed Vs_R is positive and the right wheel 2R moves forward, while the left wheel reference speed Vs_L is negative and backward movement of the left wheel 2L is assisted by the left wheel motor 25L. In this manner, turning in a narrow space is assisted.

When the wheelchair 100 moves forward and turns to the right, the wheel reference speed calculating unit 21f adds the correction speed Vc to the common reference speed Vs (addition correction), and sets the result of the addition correction as the left wheel reference speed Vs_L. The wheel reference speed calculating unit 21f subtracts the correction speed Vc from the common reference speed Vs, and sets the result of the subtraction correction as the right wheel reference speed Vs_R.

In this specification, the “addition correction” means a correction to increase the wheel reference speed of one of the left wheel 2L and the right wheel 2R to be higher than the common reference speed Vs by the absolute value of the correction speed Vc. In contrast, the “subtraction correction” means a correction to reduce the wheel reference speed of one of the left wheel 2L and the right wheel 2R to be lower than the common reference speed Vs by the absolute value of the correction speed Vc. As such, if the correction speed Vc is positive, Vs+Vc is the addition correction and Vs−Vc is the subtraction correction. In contrast, if the correction rate Vc is negative, Vs+Vc is the subtraction correction and Vs−Vc is the addition correction.

When the wheelchair 100 moves forward and turns to the right, the correction speed Vc may be calculated as a negative value. For example, when the input turning torque Th is calculated by the above-described Equation (1) or Equation (2), the input turning torque Th is calculated as a negative value at the time of right turn. As a result, the correction speed Vc calculated by Equation (3) or Equation (4) is also calculated as a negative value. In this case, the reference speeds Vs_R and Vs_L may be calculated by the following equations:

$$Vs\_R = Vs + Vc ( subtraction correction ) \\ Vs\_L = Vs - Vc = ( addition correction )$$

(In the equations above, Vs≥0, Vc<0)

With such processing, the wheel motors 25R and 25L assist for turning to the right. When the common reference speed Vs is low, the left wheel reference speed Vs_L is positive and the left wheel 2L moves forward, while the right wheel reference speed Vs_R is negative and the backward moving of the right wheel 2R can be assisted by the left wheel motor 25L. In this manner, turning in a narrow space is assisted.

The turning direction (left direction or right direction) of the wheelchair 100 can be determined based on the input turning torque Th calculated by the turning torque calculating unit 21a. For example, when the input turning torque Th is calculated by Equation (1) described above, the positive input turning torque Th indicates the left turn, and the negative input turning torque Th indicates the right turn.

### Wheel Reference Speed Calculating Unit (Reverse Mode)

When the reverse selecting switch 52b is in the “on” state, the reverse mode is selected. At this time, the common reference speed Vs calculated based on the lever operation amount may be a negative value. When the common reference speed Vs is calculated in this manner, the addition correction and the subtraction correction executed in the reverse mode and the correction of the wheel reference speeds Vs_L and Vs_R may be executed as indicated below. In the present specification, as shown in FIG. 4B(a), the left turn in the reverse mode means a turning in which the wheelchair 100 faces obliquely to the left. Further, as shown in FIG. 4B(b), the right turn in the reverse mode means a turn in which the wheelchair 100 faces obliquely to the right.

When the wheelchair 100 turns to the left in the reverse mode (FIG. 4B(a)), the wheel reference speed calculating unit 21f adds the correction speed Vc to the common reference speed Vs (addition correction), and sets the result of the addition correction as the right wheel reference speed Vs_R. Further, the wheel reference speed calculating unit 21f may subtract the correction speed Vc from the common reference speed Vs (subtraction correction), and set the result of the subtraction correction as the left wheel reference speed Vs_L.

As described above, the “addition correction” means a correction to increase the wheel reference speed of one of the left wheel 2L and the right wheel 2R to be higher than the common reference speed Vs by the absolute value of the correction speed Vc. In contrast, “subtraction correction” means a correction to reduce the wheel reference speed of one of the left wheel 2L and the right wheel 2R to be lower than the common reference speed Vs by the absolute value of the correction speed Vc.

When the wheelchair 100 moves backward and turns to the left, the correction speed Vc may be calculated as positive. For example, when the input turning torque Th is calculated by Equation (1) or Equation (2) described above, the input turning torque Th is calculated as a positive value in the left turn. As such, the correction speed Vc calculated by the Equation (3) or Equation (4) is also calculated as positive. In this case, the reference speeds Vs_R and Vs_L may be calculated by the following equations:

$$Vs\_R = Vs + Vc ( addition correction ) \\ Vs\_L = Vs - Vc ( subtraction correction )$$

(In the equations above, Vs≤0, Vc>0)

With this, the wheel motors 25R and 25L assist for the left turning. When the absolute value of the common reference speed Vs (Vs<0) is small, the right wheel reference speed Vs_R is positive and the right wheel 2R moves forward, while the left wheel reference speed Vs_L is negative and backward movement of the left wheel 2L can be assisted by the left wheel motor 25L. In this manner, turning in a narrow space is assisted.

When the wheelchair 100 turns to the right in the reverse mode (4B(b)), the wheel reference speed calculating unit 21f subtracts the correction speed Vc from the common reference speed Vs (subtraction correction), sets the result of the subtraction correction as the right wheel reference speed Vs_R. Further, the wheel reference speed calculating unit 21f adds the correction speed Vc to the common reference speed Vs (addition correction), and sets the result of the addition correction as the left wheel reference speed Vs_L. When the wheelchair 100 moves backward and turns to the right, the correction speed Vc may be calculated as negative. For example, when the input turning torque Th is calculated using Equation (1) or Equation (2) described above, the input turning torque Th is calculated as a negative value in the right turn. As such, the correction speed Vc calculated by using Equation (3) or Equation (4) is also calculated as negative. In this case, the reference speeds Vs_R and Vs_L may be calculated by the following equations:

$$Vs\_R = Vs + Vc ( subtraction correction ) \\ Vs\_L = Vs - Vc = ( addition correction )$$

(In the equations above, Vs≤0, Vc<0)

With such processing, the wheel motors 25R and 25L assist for turning to the right. When the absolute value of the common reference speed Vs (Vs≤0) is small, the right wheel reference speed Vs_R is negative and the right wheel 2R moves backward, while the left wheel reference speed Vs_L is positive and forward moving of the left wheel 2L can be assisted by the right wheel motor 25R. In this manner, turning in a narrow space is assisted.

### Command Value Calculating Unit

The command value calculating unit 21m calculates a command value based on a difference (Vs_R−V_ave) between the left and right wheel average speed V_ave and the right wheel reference speed Vs_R, and outputs a signal corresponding to the command value to the right drive unit 26R. Further, the command value calculating unit 21m calculates a command value based on a difference (Vs_L−V_ave) between the left and right wheel average speed V_ave and the left wheel reference speed Vs_L, and outputs a signal corresponding to the command value to the left drive unit 26L. When the difference in the speeds increase, the command value also increases.

When normal travel is performed, in other words, when the assistance start condition is not satisfied, the wheel reference speed calculating unit 21f sets the common reference speed Vs as the right wheel reference speed Vs_R and sets the common reference speed Vs as the left wheel reference speed Vs_L. The command value calculating unit 21m outputs, to the right drive unit 26R, a command value corresponding to the difference between the left and right wheel average speed V_ave and the right wheel reference speed Vs_R. The command value calculating unit 21m outputs, to the left drive unit 26L, a command value corresponding to the difference between the left and right wheel average speed V_ave and the left wheel reference speed Vs_L.

In this manner, the torque additionally output by the left and right wheel motors 25R and 25L (torque due to the correction speed) is zero, and the auxiliary torque for turning the wheelchair 100 is not generated. That is, in normal travel, a current corresponding to the difference between the left and right wheel average speed V_ave and the common reference speed Vs is supplied to both the right wheel motor 25R and the left wheel motor 25L. Therefore, the torque to turn the wheelchair 100 is not generated from the left and right wheel motors 25R and 25L.

### Stationary Turning Assisting Unit

The caregiver may sometimes wish to turn the wheelchair 100 without substantially changing the position of the wheelchair 100. For example, the caregiver may turn the wheelchair 100 in a narrow hallway. In this case, when the wheelchair speed Vwh is 0 or close to 0, turning in a small rotation radius is facilitated. To address this, the wheelchair 100 may have a stationary turning switch 52c (see FIG. 2). When the stationary turning switch 52c is turned on, a stationary turning assisting unit 21g (see FIG. 3) sets the common reference speed Vs to a value equal to or less than a predetermined value (e.g., substantially 0) regardless of the lever operation amount.

In this state, if the turning torque calculating unit 21a detects the turning torque Th, the correction speed calculating unit 21e, the wheel reference speed unit 21f, and the command value calculating unit 21m may execute the processing described above. That is, the correction speed calculating unit 21e calculates the correction speed Vc based on the input turning torque Th, and the wheel reference speed unit 21f calculates the wheel reference speeds Vs_R and Vs_L based on the correction speed Vc and the common reference speed Vs (e.g., substantially 0). Subsequently, the command value calculating unit 21m calculates a command value for the right wheel motor 25R based on the difference between the left and right wheel average speed V_ave and the right wheel reference speed Vs_R, and calculates a command value for the left wheel motor 25L based on the difference between the left and right wheel average speed V_ave and the left wheel reference speed Vs_L. This maintains the wheelchair speed at a small value while assisting the turning of the wheelchair 100.

The stationary turning switch 52c may be turned on when the switch is held down for a predetermined time (for example a few seconds). In the “on” state, the stationary turning switch 52c may automatically transition to the “off” state when the turning is completed, for example. More specifically, when the difference between the right wheel reference speed Vs_R and the left wheel reference speed Vs_L becomes smaller than the threshold value, the stationary turning switch 52c may automatically transition to the “off” state.

### Parameter Adjusting Unit

The parameter adjusting unit 21p receives an operation of a user (change command) and adjusts the parameters used in the processing described above. For example, the parameter adjusting unit 21p may receive an operation of the user and change the upper limit correction speed Vc_max (see Equation (3)) based on the operation. The parameter adjusting unit 21p may adjust the assistance start condition and the assistance stop condition based on the operation of the user. For example, the parameter adjusting unit 21p may change the threshold value of the input turning torque Th, which is a condition for starting the turning assistance, or change the wheelchair speed Vwh to allow the turning assistance.

As shown in FIG. 2, the wheelchair 100 may have an interface device 53 for receiving the operation of the user described above. The interface device 53 may be a touch panel or a display device to which the touch panel is attached, for example. The wheelchair 100 may include a communication device 54 (see FIG. 2) capable of communicating with a mobile terminal operated by the user.

### Flow of Processing

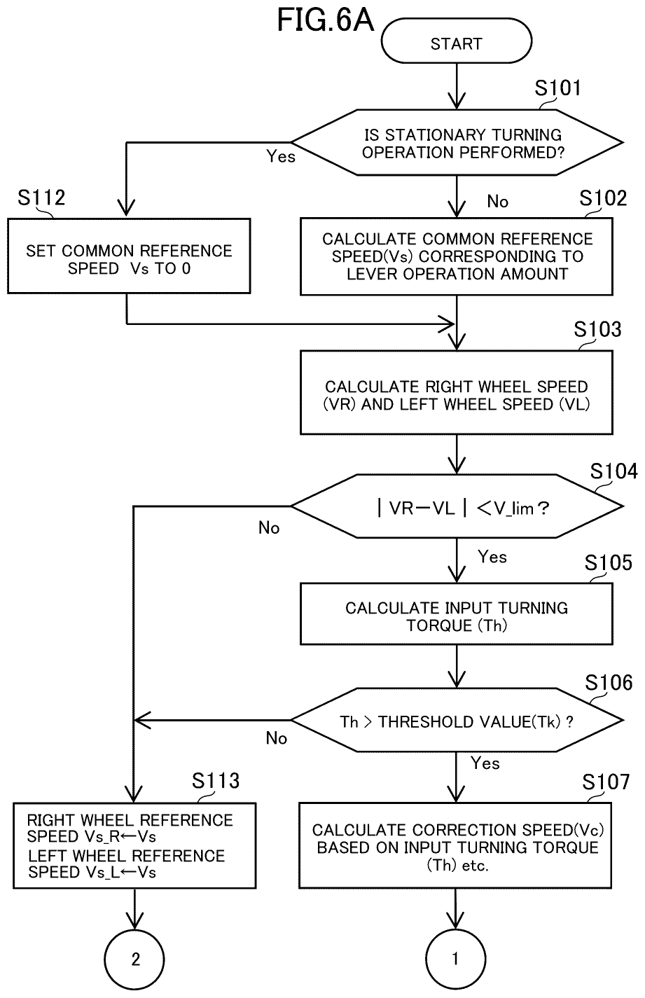

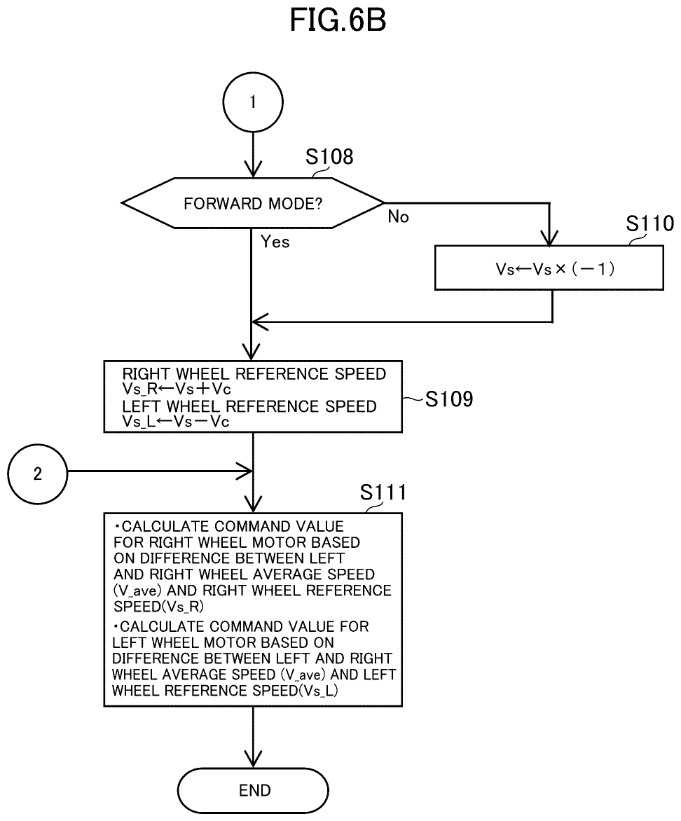

The flow of processing executed by the control device 20 will be described. FIGS. 6A and 6B are flow charts indicating examples of the processing. The control device 20 repeatedly executes the processing shown in FIGS. 6A and 6B at a predetermined cycle.

The control device 20 (stationary turning assisting unit 21g) determines whether the stationary turning switch 52c is in the “on” state (S101).

When the stationary turning switch 52c is not in the “on” state, the control device 20 (common reference speed calculating unit 21d) detects the lever operation amount and calculates the common reference speed Vs corresponding to the detected lever operation amount (S102). The operation amount detected by the control device 20 in S102 is not limited to the operation amount of the assistance travel lever 52a. For example, the rear operation input unit 52 may include operation members installed therein, such as a dial and a button. The control device 20 may detect the operation amount on these members, and calculate the common reference speed Vs corresponding to the detected operation amount. The control device 20 calculates the actual right wheel speed VR and left wheel speed VL based on the output of the speed sensors 31R and 31L (S103). Subsequently, the control device 20 (stop determining unit 21j) determines whether the absolute value of the difference between the right wheel speed VR and the left wheel speed VL is smaller than the threshold value V_lim (S104).

If the absolute value is smaller than the threshold value V_lim (“Yes” in S104), the control device 20 (turning torque calculating unit 21a) calculates the input turning torque Th (S105). As described above, if the turning torque sensor 32 (angular speed sensor) is provided in the wheelchair 100, the input turning torque Th may be calculated based on such an output. If such a sensor is not provided, the control device 20 may calculate the input turning torque Th based on the wheel speeds VR and VL by using Equation (1) or Equation (2).

Next, the control device 20 (start determining unit 21i) determines whether the input turning torque Th is greater than a threshold value Tk (S106). If the input turning torque Th is larger than the threshold value Tk, the control device 20 determines that the assistance start condition is satisfied. In S106, the control device 20 may also determine whether the average of the right wheel speed VR and the left wheel speed VL (left and right wheel average speed V_ave) is smaller than the threshold value in addition to determining whether the input turning torque Th is larger than the threshold value Tk. If the left and right wheel average speed V_ave is smaller than the threshold value, the control device 20 may determine that the assistance start condition is satisfied.

When the assistance start condition is satisfied (“Yes” in S106), the control device 20 (correction speed calculating unit 21e) calculates the correction speed Vc (S107). As described above, the correction speed Vc is calculated based on the upper limit correction speed Vc_max and the input turning torque Th referring to Equation (3), for example. The correction speed Vc may be calculated based on the upper limit correction speed Vc_max, the input turning torque Th, and the wheelchair speed Vwh by using Equation (4).

Subsequently, the control device 20 (wheel reference speed calculating unit 21f) determines whether the wheelchair 100 is in the forward mode (S108). Specifically, the wheel reference speed calculating unit 21f determines whether the reverse selecting switch 52b is in the “on” state. When the reverse selecting switch 52b is not in the “on” state, it is determined that the wheelchair 100 is in the forward mode.

When the wheelchair 100 is in the forward mode (“Yes” in S108), the control device 20 (wheel reference speed calculating units 21f) adds the correction speed Vc to the common reference speed Vs, and sets the result of the addition as the right wheel reference speed Vs_R (Vs+Vc, S111). Further, the correction speed Vc is subtracted from the common reference speed Vs, and the result of the subtraction is set as the left wheel reference speed Vs_L (Vs−Vc, S111).

When the wheelchair 100 turns to the left, the correction speed Vc may be calculated as a positive value in S107. For example, the correction speed Vc calculated by Equation (3) or Equation (4) is calculated as a positive value at the time of left turn. In this case, the reference speeds Vs_R and Vs_L are calculated in S108 by the following equations:

$$Vs\_R = Vs + Vc ( addition correction ) \\ Vs\_L = Vs - Vc ( subtraction correction )$$

(In the equations above, Vs>0, Vc>0)

In contrast, when the wheelchair 100 turns to the right, the correction speed Vc may be calculated as negative in S107. For example, the correction speed Vc calculated by Equation (3) or (4) is calculated as a negative value at the time of a right turn. In this case, the reference speeds Vs_R and Vs_L are calculated in S108 by the following equations:

$$Vs\_R = Vs + Vc ( subtraction correction ) \\ Vs\_L = Vs - Vc = ( addition correction )$$

(In the equations above, Vs>0, Vc<0)

When the wheelchair 100 is in the reverse mode (“No” in S108), the control device 20 sets the common reference speed Vs corresponding to the lever operation amount detected in S102 to a negative value (Vs←Vs×(−1), S110). The control device 20 (wheel reference speed calculating unit 21f) adds the correction speed Vc to the common reference speed Vs, and sets the result of the addition as the right wheel reference speed Vs_R (Vs+Vc, S111). Further, the control device 20 subtracts the correction speed Vc from the common reference speed Vs, and the sets the result of the subtraction as the left wheel reference speed Vs_L (Vs−Vc, S111).

In the reverse mode as well, when the wheelchair 100 turns to the left, the correction speed Vc is calculated as positive by Equation (3) or Equation (4). The reference speeds Vs_R and Vs_L are calculated in S108 by the following equations:

$$Vs\_R = Vs + Vc ( addition correction ) \\ Vs\_L = Vs - Vc ( subtraction correction )$$

(In the equations above, Vs<0, Vc>0)

In contrast, when the wheelchair 100 turns to the right, the correction speed Vc is calculated as a negative value by Equation (3) or (4). The reference speeds Vs_R and Vs_L are calculated in S108 by the following equations:

$$Vs\_R = Vs + Vc ( subtraction correction ) \\ Vs\_L = Vs - Vc = ( addition correction )$$

(In the equations above, Vs<0, Vc<0)

Next, the control device 20 (command value calculating unit 21m) calculates a command value based on the difference between the right wheel reference speed Vs_R and the left and right wheel average speed V_ave obtained in S109, and outputs a signal corresponding to the command value to the right drive unit 26R (S111). Similarly, the control device 20 calculates a command value based on the difference between the left wheel reference speed Vs_L and the left and right wheel average speed V_ave, and outputs a signal corresponding to the command value to the left drive unit 26L (S111).

In S101, when the stationary turning switch 52c is in the “on” state (“Yes” in S101), the control device 20 (stationary turning assisting unit 21g) sets 0 as the common reference speed Vs (S112). The control device 20 then executes the processing subsequent to S103. In this manner, the wheelchair 100 is turned while being assisted by the wheel motors 25R and 25L without changing its position.

In S104, if the absolute value of the difference between the right wheel speed VR and the left wheel speed VLis larger than the threshold value V_lim (“No” in S104), it is not appropriate to assist the turning by the wheel motors 25R and 25L. As such, the control device 20 does not calculate the correction speed Vc but sets the common reference speed Vs obtained in S102 as the right wheel reference speed Vs_R and the left wheel reference speed Vs_L (S113).

Similarly, in S106, if the input turning torque Th is smaller than the threshold value Tk (“No” in S106), it is considered that the assistance of the wheel motors 25R and 25L for turning is not necessary. As such, the control device 20 does not calculate the correction speed Vc but sets the common reference speed Vs obtained in S102 as the right wheel reference speed Vs R and the left wheel reference speed Vs_L (S117).

The control device 20 then executes processing in S111. In this manner, the torque additionally output by the right and left wheel motors 25R and 25L (torque caused by the correction speed) is zero, and the auxiliary torque for turning the wheelchair 100 is not generated. The left and right wheel average speed V_ave follows the common reference speed Vs.

### Change in Reference Speed

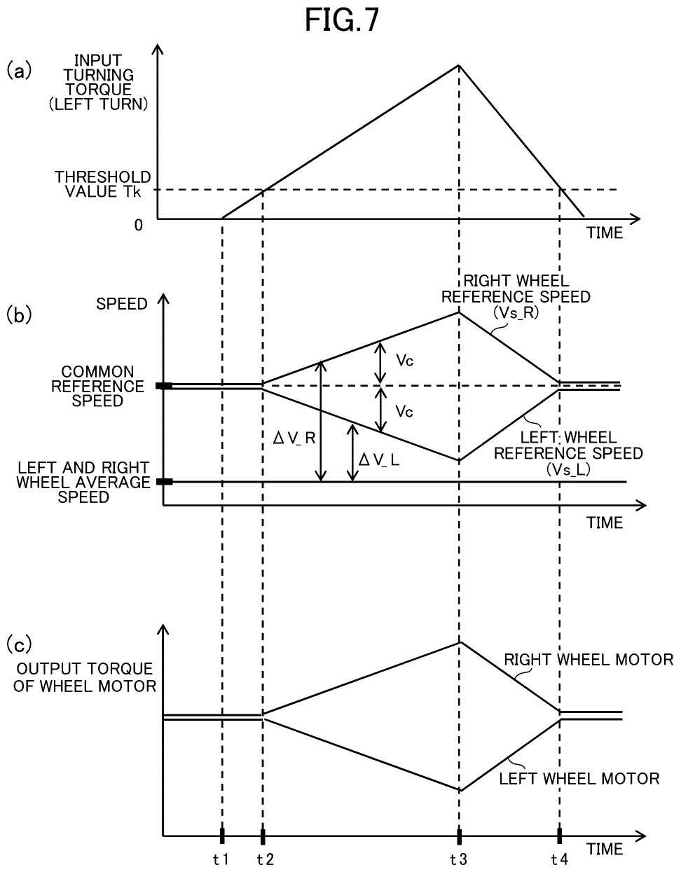

FIG. 7 is a time chart showing examples of changes in (a) input turning torque Th, (b) reference speeds Vs Vs_R and Vs_L, and (c) output torque of wheel motors 25R and 25L. The changes that happen when the caregiver is trying to turn the wheelchair 100 to the left will be described.

At the time point t1, the input turning torque Th increases from 0 (FIG. 7(a)). Until the time point t2 is reached, the input turning torque Th is lower than the threshold value Tk (S106), and thus the turning assistance does not start. As such, the right wheel reference speed Vs_R and the left wheel reference speed Vs_L both remain in the common reference speed Vs (FIG. 7(b)).

At the time point t2, when the input turning torque Th exceeds the threshold value Tk, the turning assistance starts. The correction speed Vc is then calculated based on the input turning torque Th (FIG. 7(b)). Consequently, the right wheel reference speed Vs_R increases from the common reference speed Vs, while the left wheel reference speed Vs_L decreases from the common reference speed Vs.

Accordingly, the difference ΔV_R between the left and right wheel average speed V_ave and the right wheel reference speed Vs_R increases, and the difference ΔV_L between the left and right wheel average speed V_ave and the left wheel reference speed Vs_L decreases. In this manner, the output torque of the right wheel motor 25R increases from the output torque corresponding to the common reference speed Vs that has been output by the time point t2. Consequently, the rotational speed of the right wheel motor 25R is higher than the rotational speed corresponding to the common reference speed Vs.

In contrast, the output torque of the left wheel motor 25L decreases from the output torque corresponding to the common reference speed Vs that has been output by the time point t2. This reduces the rotational speed of the left wheel motor 25L lower than the rotational speed corresponding to the common reference speed Vs. In this manner, the wheel motors 25R and 25L assist the turning of the wheelchair 100.

In the example shown in FIG. 7, the input turning torque Th gradually increases until the time point t3, and thus the correction speed Vc also gradually increases. Consequently, the output torque of the right wheel motor 25R gradually increases, and the output torque of the left wheel motor 25L gradually decreases. During the period from the time point t3 to the time point t4, the input turning torque Th gradually decreases, and thus the correction speed Vc also gradually decreases. Consequently, the output torque of the right wheel motor 25R gradually decreases, and the output torque of the left wheel motor 25L gradually increases.

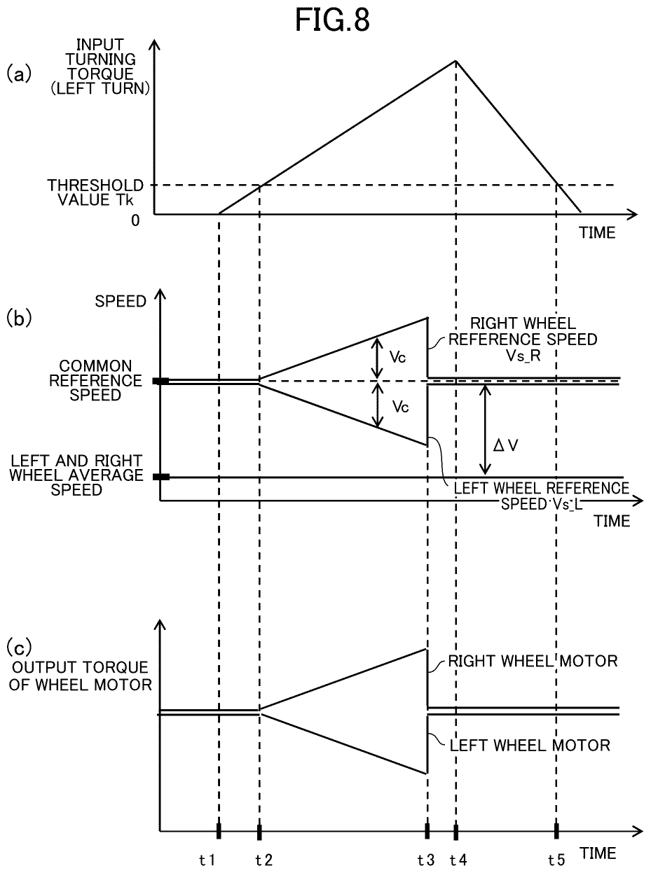

FIG. 8 is a time chart showing examples of change in (a) input turning torque Th, (b) reference speeds Vs, Vs_R and Vs_L, and (c) output torque of wheel motors 25R and 25L. In FIG. 8, the changes up to the time point t3 are the same as those in FIG. 7, and thus the explanation thereof is omitted.

As described above, the stop determining unit 21j determines whether the assistance stop condition is satisfied. As shown in S104 in FIG. 6A, for example, the assistance stop condition is to satisfy that the absolute value of the difference between the right wheel speed VR and the left wheel speed VL is larger than the threshold value V_lim. In FIG. 8, at the time point t3, the absolute value of the difference between the right wheel speed VR and the left wheel speed VL exceeds the threshold value V_lim. As such, after the time point t3, the correction speed Vc corresponding to the input turning torque Th is not calculated, and the common reference speed Vs is set as the right wheel reference speed Vs_R and the left wheel reference speed Vs_L (see FIG. 8(b)). Accordingly, after the time point t3, the output torque of the right wheel motor 25R and the output torque of the left wheel motor 25L are both set to the same value (torque at the time point t2 before turning assistance starts) based on the difference ΔV between the common reference speed Vs and the left and right wheel average speed V_ave. With this, the assistance of the wheel motors 25R and 25L in turning is terminated.

Unlike the example shown in FIG. 8, when the absolute value of the difference between the right wheel speed VR and the left wheel speed VL exceeds the threshold value V_lim, the correction may not be stopped but the correction speed Vc may be gradually decreased.

### Conclusion

(1) When a force (torque) to turn a wheelchair 100 to a left direction is detected, a control device 20 increases a rotational speed of a right wheel motor 25R from a rotational speed corresponding to a common reference speed Vs and decreases a rotational speed of the left wheel motor 25L from the rotational speed corresponding to the common reference speed Vs. Further, when the force to turn the wheelchair 100 to a right direction is detected, the control device 20 increases a rotational speed of the left wheel motor 25L from a rotational speed corresponding to the common reference speed and decreases a rotational speed of the right wheel motor 25R from the rotational speed corresponding to the common reference speed Vs. This can reduce the burden on the caregiver when turning the wheelchair 100, while reducing the changes in the speed of the wheelchair 100.
(2) In (1), when a force to turn the wheelchair 100 to the left direction is detected, the control device 20 performs an addition correction to add the correction speed Vc, controls the right wheel motor 25R based on the result of the addition correction (right wheel reference speed Vs_R), performs a subtraction correction to subtract the correction speed Vc, and controls the left wheel motor 25L based on the result of the subtraction correction (left wheel reference speed Vs_L).
(3) In (1) or (2), at the time of the left turn, the control device 20 controls the right wheel motor 25R based on the addition result obtained by adding the correction speed Vc to the common reference speed Vs, and controls the left wheel motor 25L based on the subtraction result obtained by subtracting the correction speed Vs from the common reference speed Vs. At the time of the right turn, the control device 20 controls the left wheel motor 25L based on the addition result obtained by adding the correction speed Vc to the common reference speed Vs, and controls the right wheel motor 25R based on the subtraction result obtained by subtracting the correction speed Vs from the common reference speed Vs.
(4) In (2), when the difference between the right wheel speed VR obtained by the right speed sensor 31R and the left wheel speed VL obtained by the left speed sensor 31L satisfies a predetermined condition (VR−VL>V_lim or VR−VL<−V_lim), the control device 20 relaxes at least one of the addition correction and the subtraction correction. This serves to prevent excessively high turning speed.
(5) In any one of (1) to (4), the control device 20 calculates the correction speed Vc based on at least one of the input turning torque Th and the wheelchair speed Vwh and the upper limit value (upper limit correction speed Vc_max) set for the correction speed Vc in advance. This serves to keep the correction speed Vc smaller than the upper limit correction speed Vc_max, for example, and increase the correction speed Vc in accordance with the force to turn the wheelchair 100. Alternatively, the correction speed Vc can be kept smaller than the upper limit correction speed Vc_max and set to a value corresponding to the wheelchair speed Vwh.
(6) In any one of (1) to (5), the control device 20 calculates the common reference speed Vs according to the operation amount of the assistance travel lever 52a. In this manner, the wheelchair 100 can be controlled to travel at a speed corresponding to the operation amount. The rear operation input unit 52 may include operation members installed therein, such as a dial and a button, instead of the assistance travel lever 52a. The control device 20 may detect the operation amount on these members, and calculate the common reference speed Vs corresponding to the detected operation amount.
(7) In any one of (1) to (6), the control device 20 calculates the correction speed Vc based on the force acting on the wheelchair 100 (input turning torque Th). In this manner, it is possible to obtain assistance corresponding to the force applied to the electric wheelchair 100 by the caregiver.
(8) In any one of (1) to (7), the control device 20 calculates the force to turn the wheelchair 100 based on an angular speed around a vertical axis line of the wheelchair 100.
(9) In any one of (1) to (8), the control device 20 controls the right wheel motor 25R and the left wheel motor 25L based on the differences between the average of the right wheel speed and the left wheel speed (left and right wheel average speed V_ave) and the common reference speed Vs. Upon detecting the force to turn the wheelchair 100, the control device 20 adds the correction speed Vc to one of the left and right wheel average speed V_ave and the common reference speed Vs, and controls one of the right wheel motor 25R and the left wheel motor 25L based on the result of the addition. Further, the correction speed Vc is subtracted from one of the left and right wheel average speed V_ave and the common reference speed Vs, and the other one of the right wheel motor 25R and the left wheel motor 25L is controlled based on the result of the subtraction.
(10) In any one of (2) to (9), the control device 20 calculates the correction speed Vc based on the wheelchair speed Vwh. This can prevent sudden turning at high speed, for example.
(11) In (10), a first correction value is calculated as the correction value Vc when a speed of the electric wheelchair 100 is lower than a threshold value Vwh1 (FIG. 5A). Further, a second correction value is calculated as the correction value Vc when a speed of the electric wheelchair 100 is in a range (medium speed range, high speed range) higher than a threshold value Vwh1 (FIG. 5A). the first correction value is greater than the second correction value. This can prevent sudden turning at high speed.
(12) In any one of (1) to (11), the control device 20 detects an operation of the stationary turning switch 52c, and limits the common reference speed Vs to a predetermined value or less based on the operation. This enables the turning assisted by the wheel motors 25R with a low speed of the wheelchair 100. In this manner, turning in a narrow space can be easily performed.
(13) In any one of (2) to (13), the control device 20 receives a command for changing the upper limit value of the correction speed Vc (upper limit correction speed Vc_max) from the user. This prevents excessive turning assistance that is not intended by the user.
(14) In (2), if the common reference speed Vs is lower than the correction speed Vc, the control device 20 sets the rotation speed of one of the right wheel motor 25R and the left wheel motor 25L as a positive value by the addition correction, and sets the rotation speed of the other one of the right wheel motor 25R and the left wheel motor 25L as a negative value by the subtraction correction. This enables the turn in a narrow place with a light load.

### Other Examples

The drive system proposed in the present disclosure is not limited to the examples described above.

### Example of Wheel Speed Correction

For example, in the examples described above, the common reference speed Vs is corrected by the correction speed Vc. However, the wheel speeds VR and VL may be corrected by the correction speed Vc.

For example, at the time of the left turn, the correction speed Vc may be subtracted from the left and right wheel average speed V_ave, and a command value corresponding to the difference between the subtraction result and the common reference speed Vs may be output to the right drive unit 26R. At this time, the correction speed Vc may be added to the left and right wheel average speed V_ave, and a command value corresponding to the difference between the addition result and the common reference speed Vs may be output to the left drive unit 26L. This increases the output torque of the right wheel motor 25R, and thus the rotational speed of the right wheel motor 25R becomes higher than the rotational speed corresponding to the common reference speed Vs. In contrast, the output torque of the left wheel motor 25L is decreased, and thus the rotational speed of the left wheel motor 25L becomes lower than the rotational speed corresponding to the common reference speed Vs.

At the time of the right turn, the correction speed Vc may be subtracted from the left and right wheel average speed V_ave, and a command value corresponding to the difference between the subtraction result and the common reference speed Vs may be output to the left drive unit 26L. At this time, the correction speed Vc may be added to the left and right wheel average speed V_ave, and a command value corresponding to the difference between the addition result and the common reference speed Vs may be output to the right drive unit 26R. This increases the output torque of the left wheel motor 25L, and thus the rotational speed of the left wheel motor 25L becomes higher than the rotational speed corresponding to the common reference speed Vs. In contrast, the output torque of the right wheel motor 25R is decreased, and thus the rotational speed of the right wheel motor 25R becomes lower than the rotational speed corresponding to the common reference speed Vs.

### Other Examples of Reference Speed

In the examples described above, the speed in the front-rear direction is used as the common reference speed Vs. However, the common reference speed Vs may be a reference value for the rotational speed of the wheels 2R and 2L and the rotational speed of the wheel motors 25R and 25L. In this case, the correction speed Vc calculated by referring to FIGS. 5A and 5B, for example, may be a correction value for the rotational speed of the wheels 2R and 2L.

In this case, at the time of left turn, the control device 20 increases the rotational speed of the right wheel motor 25R from the reference rotational speed (common reference speed) and decreases the rotational speed of the left wheel motor 25L from the common rotational speed (common reference speed). In contrast, at the time of right turn, the control device 20 increases the rotational speed of the left wheel motor 25L from the reference rotational speed (common reference speed) and decreases the rotational speed of the right wheel motor 25R from the common rotational speed (common reference speed).

### Other Examples of Correction Speed

In the above explanation, the correction speed Vc is calculated by Equation (3) or Equation (4). As such, the correction speed Vc is a positive value at the time of a left turn and a negative value at t the time of right turn. Accordingly, at the time of left turn, Vs+Vc is the addition correction and Vs−Vc is the subtraction correction. Further, at the time of the right turn, Vs+Vc is the subtraction correction and Vs−Vc is the addition correction. However, the correction speed Vc may be calculated so as to be positive at both of the left turn and the right turn. In this case, in both the left turn and the right turn, Vs+Vc may be executed as the addition correction and Vs−Vc may be executed as the subtraction correction.

Although the present invention has been illustrated and described herein with reference to embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A drive system for mounting on an electric wheelchair including a right wheel and a left wheel, comprising:
a right wheel motor that drives the right wheel;
a left wheel motor that drives the left wheel;
a force sensor that detects an externally applied force to turn the electric wheelchair; and
a control device that controls the right wheel motor and the left wheel motor based on a common reference speed, wherein
the control device is configured to:
at a time of a left turn in which the force to turn the electric wheelchair in a left direction is detected, increase a rotational speed of the right wheel motor from a rotational speed corresponding to the common reference speed and decrease a rotational speed of the left wheel motor from the rotational speed corresponding to the common reference speed, and
at a time of a right turn in which the force to turn the electric wheelchair in a right direction is detected, increase a rotational speed of the left wheel motor from a rotational speed corresponding to the common reference speed and decrease a rotational speed of the right wheel motor from the rotational speed corresponding to the common reference speed.

2. The drive system for mounting on the electric wheelchair according to claim 1, wherein
when the force to turn the electric wheelchair is detected, the control device is configured to:
perform a first correction, which is one of an addition of a correction value or a subtraction of the correction value, and control one of the right wheel motor and the left wheel motor based on a result of the first correction, and
perform a second correction, which is the other one of the addition of the correction value and the subtraction of the correction value, and control the other one of the right wheel motor and the left wheel motor based on a result of the second correction.

3. The drive system for mounting on the electric wheelchair according to claim 1, wherein
the control device is configured to:
at the time of the left turn, control the right wheel motor based on an addition result and control the left wheel motor based on a subtraction result, the addition result being a result of adding a correction value to the common reference speed, the subtraction result being a result of subtracting the correction value from the common reference speed, and
at the time of the right turn, controls the left wheel motor based on the addition result and controls the right wheel motor based on the subtraction result, the addition result being a result of adding a correction value to the common reference speed, the subtraction result being a result of subtracting a correction value from the common reference speed.

4. The drive system for mounting on the electric wheelchair according to claim 2, further comprising:
a right speed sensor that outputs a signal corresponding to a speed of the right wheel; and
a left speed sensor that outputs a signal corresponding to a speed of the left wheel, wherein
when a difference between the speed obtained by the right speed sensor and the speed obtained by the left speed sensor satisfies a predetermined condition, the control device relaxes at least one of the first correction or the second correction so that a difference between a rotational speed of the left wheel motor and a rotational speed of the right wheel motor is reduced.

5. The drive system for mounting on the electric wheelchair according to claim 2, wherein
the control device calculates the correction value based on at least one of the force to turn the electric wheelchair or the speed of the electric wheelchair and an upper limit value that is set for the correction value in advance.

6. The drive system for mounting on the electric wheelchair according to claim 1, wherein
the control device calculates the common reference speed according to an operation amount acting on an operation member included in the electric wheelchair.

7. The drive system for mounting on the electric wheelchair according to claim 2, wherein
the control device calculates the correction value based on an externally applied force acting on the electric wheelchair.

8. The drive system for mounting on the electric wheelchair according to claim 1, wherein
the control device calculates the force to turn the electric wheelchair based on an angular speed around a vertical axis line of the electric wheelchair.

9. The drive system for mounting on the electric wheelchair according to claim 1, further comprising:
a right speed sensor that outputs a signal corresponding to a speed of the right wheel; and
a left speed sensor that outputs a signal corresponding to a speed of the left wheel, wherein
the control device controls the right wheel motor and the left wheel motor based on a difference between an average of the right wheel speed and the left wheel speed and the common reference speed,
upon detecting the force to turn the electric wheelchair, the control device:
adds a correction value to one of the average or the common reference speed and controls one of the right wheel motor and the left wheel motor based on a result of the addition, and
subtracts the correction value from the one of the average and the common reference speed and controls the other one of the right wheel motor and the left wheel motor based on a result of the subtraction.

10. The drive system for mounting on the electric wheelchair according to claim 2, wherein
the control device calculates the correction value based on a speed of the electric wheelchair.

11. The drive system for mounting on the electric wheelchair according to claim 10, wherein
a first correction value is calculated as the correction value when a speed of the electric wheelchair is a first speed that is smaller than a threshold value,
a second correction value is calculated as the correction value when a speed of the electric wheelchair is a second speed that is greater than the threshold value, and
the first correction value is greater than the second correction value.

12. The drive system for mounting on the electric wheelchair according to claim 1, wherein
the control device detects an operation applied by a caregiver to an operation member provided on the electric wheelchair, and limits the common reference speed to a predetermined value or less in response to the operation.

13. The drive system for mounting on the electric wheelchair according to claim 2, wherein
the control device receives a command from a user for changing an upper limit value of the correction value.

14. The drive system for mounting on the electric wheelchair according to claim 2, wherein
when the common reference speed is lower than the correction value, the control device sets a rotational speed of the one of the right wheel motor and the left wheel motor to a positive value by the first correction, and sets a rotational speed of the other one of the right wheel motor and the left wheel motor to a negative value by the second correction.

15. An electric wheelchair comprising:
a right wheel;
a left wheel; and
a drive system,
the drive system including:
a right wheel motor that drives the right wheel;
a left wheel motor that drives the left wheel;
a force sensor that detects an externally applied force to turn the electric wheelchair; and
a control device that controls the right wheel motor and the left wheel motor based on a common reference speed, wherein
the control device is configured to:
at a time of a left turn in which the force to turn the electric wheelchair in a left direction is detected, increase a rotational speed of the right wheel motor from a rotational speed corresponding to the common reference speed and decrease a rotational speed of the left wheel motor from the rotational speed corresponding to the common reference speed, and
at a time of a right turn in which the force to turn the electric wheelchair in a right direction is detected, increase a rotational speed of the left wheel motor from a rotational speed corresponding to the common reference speed and decrease a rotational speed of the right wheel motor from the rotational speed corresponding to the common reference speed.

16. A method for controlling an electric wheelchair including a right wheel, a left wheel, a right wheel motor that drives the right wheel, and a left wheel motor that drives the left wheel, the method comprising;
detecting an externally applied force to turn the electric wheelchair; and
controlling the right wheel motor and the left wheel motor based on a common reference speed, wherein
the controlling step includes:
at a time of a left turn in which the force to turn the electric wheelchair in a left direction is detected, increasing a rotational speed of the right wheel motor from a rotational speed corresponding to the common reference speed and decreasing a rotational speed of the left wheel motor from the rotational speed corresponding to the common reference speed, and
at a time of a right turn in which the force to turn the electric wheelchair in a right direction is detected, increasing a rotational speed of the left wheel motor from a rotational speed corresponding to the common reference speed and decreasing a rotational speed of the right wheel motor from the rotational speed corresponding to the common reference speed.

17. A non-transitory information storage medium storing a program for causing a computer to function as a control device of an electric wheelchair including a right wheel, a left wheel, a right wheel motor that drives the right wheel, and a left wheel motor that drives the left wheel, the program for causing the computer to function as:
a detector for detecting an externally applied force to turn the electric wheelchair; and
a controller for controlling the right wheel motor and the left wheel motor based on a common reference speed, wherein
the contoller includes:
at a time of a left turn in which the force to turn the electric wheelchair in a left direction is detected, increasing a rotational speed of the right wheel motor from a rotational speed corresponding to the common reference speed and decreasing a rotational speed of the left wheel motor from the rotational speed corresponding to the common reference speed, and
at a time of a right turn in which the force to turn the electric wheelchair in a right direction is detected, increasing a rotational speed of the left wheel motor from a rotational speed corresponding to the common reference speed and decreasing a rotational speed of the right wheel motor from the rotational speed corresponding to the common reference speed.
